(19) United States
(12) Patent Application Publication
(10) Pub. No.: US 2012/0128074 A1
(43) Pub. Date: May 24, 2012

(54) VIDEO CODING USING SPATIALLY VARYING TRANSFORM

(75) Inventors: Cixun Zhang, Tampere (FI); Kemal Ugur, Tampere (FI); Jani Lainema, Tampere (FI)

(73) Assignee: NOKIA CORPORATION, Espoo (FI)

(21) Appl. No.: 13/058,972

(22) PCT Filed: Aug. 12, 2008
(86) PCT No.: PCT/EP2008/060604

§ 371 Date: Oct. 10, 2011

(51) Int. Cl. H04N 7/26; H04N 7/30

(52) U.S. Cl. 375/240.18; 375/240.24; 375/E07.226; 375/E07.026

(57) ABSTRACT

Transform coding is not restricted inside normal block boundary but is adjusted to the characteristics of the prediction error. Thereby it is possible to achieve a coding efficiency improvement by selecting and coding the best portion of the prediction error in terms of rate distortion tradeoff.

### FIELD OF THE INVENTION

The present invention relates to apparatus for coding and decoding and specifically but not only for coding and decoding of image and video signals

### BACKGROUND OF THE INVENTION

A video codec comprises an encoder which transforms input video into a compressed representation suitable for storage and/or transmission and a decoder than can uncompress the compressed video representation back into a viewable form. Typically, the encoder discards some information in the original video sequence in order to represent the video in a more compact form, for example at a lower bit rate.

Typical video codecs, for example International Telegraphic Union-Technical Board (ITU-T) H.263 and H.264 coding standards, encode video information in two phases. In the first phase, pixel values in a certain picture area or “block” are predicted. These pixel values can be predicted, for example, by motion compensation mechanisms, which involve finding and indicating an area in one of the previously encoded video frames (or a later coded video frame) that corresponds closely to the block being coded. Additionally, pixel values can be predicted by spatial mechanisms which involve finding and indicating a spatial region relationship.

The second phase is one of coding the error between the predicted block of pixels and the original block of pixels. This is typically accomplished by transforming the difference in pixel values using a specified transform. This transform is typically a Discrete Cosine Transform (DCT) or a variant thereof. After transforming the difference, the transformed difference is quantized and entropy encoded.

By varying the fidelity of the quantisation process, the encoder can control the balance between the accuracy of the pixel representation, (in other words, the quality of the picture) and the size of the resulting encoded video representation (in other words, the file size or transmission bit rate).

The decoder reconstructs the output video by applying a prediction mechanism similar to that used by the encoder in order to form a predicted representation of the pixel blocks (using the motion or spatial information created by the encoder and stored in the compressed representation of the image) and prediction error decoding (the inverse operation of the prediction error coding to recover the quantised prediction signal in the spatial domain).

After applying pixel prediction and error decoding processes the decoder combines the prediction and the prediction error signals (the pixel values) to form the output video frame.

The decoder (and encoder) may also apply additional filtering processes in order to improve the quality of the output video before passing it for display and/or storing as a prediction reference for the forthcoming frames in the video sequence.

In typical video codecs, the motion information is indicated by motion vectors associated with each motion compensated image block. Each of these motion vectors represents the displacement of the image block in the picture to be coded (in the encoder) or decoded (at the decoder) and the prediction source block in one of the previously coded or decoded images (or pictures). In order to represent motion vectors efficiently, motion vectors are typically coded differentially with respect to block specific predicted motion vector. In a typical video codec, the predicted motion vectors are created in a predefined way, for example by calculating the median of the encoded or decoded motion vectors of the adjacent blocks.

Typical video encoders utilise the Lagrangian cost function to find optimal coding modes, for example the desired macro block mode and associated motion vectors. This type of cost function uses a weighting factor or λ to tie together the exact or estimated image distortion due to lossy coding methods and the exact or estimated amount of information required to represent the pixel values in an image area.

This may be represented by the equation:

C=D+λR

where C is the Lagrangian cost to be minimised, D is the image distortion (in other words the mean-squared error) with the mode and motion vectors currently considered, and R is the number of bits needed to represent the required data to reconstruct the image block in the decoder (including the amount of data to represent the candidate motion vectors).

Currently codecs encode the residual signal typically using a M×N DCT transform. However, edge detail within these M×N macro blocks prevents the basis functions of the transform from being able to exploit any correlation in the residual signal and may produce a lower coding efficiency.

Bjontegaard and Fuldseth in the document titled “Larger transform for residual signal coding” VCEG Doc. VCEG-Y10, January 2005, available online: http://ftp3.itu.ch/av-arch/video-site/0501_Hon/ discusses using a 16×16 transform for a whole 16×16 macro block but only encoding the 4×4 pixel block low frequency coefficients. However, in such an approach, the problem with correlation and coding efficiency above is still present especially where an edge feature is present inside the 16×16 pixel macro block. Furthermore the encoding of 4×4 pixel blocs produces increased decoding complexity.

Wien in the document “Variable Block-Size Transforms for H.264/AVC”, IEEE Transactions on circuits and systems for video technology, vol. 13 no. 7, July 2003 describes a system where alignment of the block size used for transform coding of the prediction error to the block size used for motion compensation occurs. However, such an approach may, where edges occur within a block, produce a sub-optimal coding efficiency.

### SUMMARY OF THE INVENTION

This invention proceeds from the consideration that by using a spatially variable region or block within a macro block, the residual error coding process may produce a more optimally encoded image.

Embodiments of the present invention aim to address the above problem.

According to a first aspect of the invention, there is provided an apparatus configured to select a first set of pixels from a macroblock of pixels, transform the first set of pixels, and encode the transformed first set of pixels.

The macroblock of pixels may be associated with a further block of pixels and the apparatus further configured to determine a correlation between the selected first set of pixels and a corresponding set of pixels from the further block of pixels, wherein the selection of the first set of pixels is dependent on the correlation between the selected first set of pixels and the corresponding set of pixels from the further block of pixels.

The apparatus may be further configured to generate a cost function, wherein the cost function is dependent on the correlation between the selected first set of pixels and the corresponding set of pixels from the further block of pixels, and minimise the value of the cost function. The first set of pixels may be selected from at least one of a plurality of sets of pixels from the macroblock of pixels, wherein the cost function is dependent on the number of the plurality of sets of pixels.

The apparatus may be further configured to assign at least one value to the macroblock pixels that have not been selected. The cost function value may be further dependent on the number of values assigned to the macroblock pixels that have not been selected

The apparatus may be further configured to select a filter for application in the macroblock of pixels. The cost function value may be further dependent on the filter selection.

Each of the plurality of sets of pixels from the macroblock of pixels may be associated with a different position within the macroblock of pixels.

The apparatus may be further configured to assign a value indicating the position of the selected first set of pixels within the macroblock of pixels, and encode the value indicating the position of the selected first set of pixels.

The apparatus configured to encode the value indicating the position of the selected first set of pixels may be further configured to encode the value indicating the position of the selected first set of pixels based on information derived from the macroblock of pixels.

The apparatus configured to encode the value indicating the position of the selected first set of pixels may be further configured to encode the value indicating the position of the selected first set of pixels based on information derived from a neighbouring macroblock of pixels.

The further block or pixels may be dependent on the encoded transformed first set of pixels and the at least one value assigned to the macroblock pixels that have not been selected.

According to a further aspect of the invention, there is provided an apparatus configured to determine a first part of a signal representing a first set of pixel values from a macroblock of pixels, regenerate the first set of pixel values from the first part of the signal, regenerate the remaining pixels from the macroblock of pixels from a second part of the signal, and combine the first set of pixel values and the remaining pixels to regenerate a macroblock of pixels.

The apparatus configured to regenerate of the first set of pixel values may be further configured to dequantize the first part of the signal, and inverse transforming a dequantized first part of the signal.

The apparatus configured to regenerate the remaining pixels from the macroblock of pixels may be further configured to assign at least one value from the second part of the signal to each pixel.

The apparatus configured to combine the first set of pixel values and the remaining pixels to regenerate a macroblock of pixels may be further configured to filter the boundary between the first set of pixel values and the remaining pixels.

The apparatus may be further configured to filter the boundary of the macroblock. The filter may comprise a de-blocking filter.

The apparatus configured to dequantise the first part of the signal may be further configured to decode the position value associated with the first part of the signal.

An electronic device may comprise apparatus as described above.

A chipset may comprise apparatus as described above.

An encoder may comprise apparatus as described above.

A decoder may comprise apparatus as described above.

According to a further aspect of the invention, there is provided a method comprising selecting a first set of pixels from a macroblock of pixels, transforming the first set of pixels, and encoding the transformed first set of pixels.

The macroblock of pixels may be associated with a further block of pixels and said method may further comprise determining a correlation between the selected first set of pixels, wherein the selection of the first set of pixels is dependent on the correlation between the selected first set of pixels and the corresponding set of pixels from the further block of pixels.

The method may further comprise generating a cost function, wherein the cost function is dependent on the correlation between the selected first set of pixels and the corresponding set of pixels from the further block of pixels, and minimizing the value of the cost function.

The first set of pixels may be selected from at least one of a plurality of sets of pixels from a macroblock of pixels, wherein the cost function is dependent on the number of the plurality of sets of pixels.

The method may further comprise assigning at least one value to the macroblock pixels that have not been selected.

The cost function value may be further dependent on the number of values assigned to the macroblock pixels that have not been selected.

The method may further comprise selecting a filter for application in the macroblock of pixels.

The cost function value may be further dependent on the filter selection.

Each of the plurality of sets of pixels from the macroblock of pixels may be associated with a different position within the macroblock of pixels.

The method may further comprise assigning a value indicating the position of the selected first set of pixels within the macroblock of pixels, and encoding the value indicating the position of the selected first set of pixels.

Encoding the value indicating the position of the selected first set of pixels may further comprise encoding the value indicating the position of the selected first set of pixels based on information derived from the macroblock of pixels.

Encoding the value indicating the position of the selected first set of pixels may further comprise encoding the value indicating the position of the selected first set of pixels based on information derived from a neighbouring macroblock of pixels.

The further block or pixels may be dependent on the encoded transformed first set of pixels and the least one value assigned to the macroblock pixels that have not been selected.

According to a further aspect of the invention, there is provided a method comprising determining a first part of a signal representing a first set of pixel values from a macroblock of pixels, regenerating the first set of pixel values from the first part of the signal, regenerating the remaining pixels from the macroblock of pixels from a second part of the signal, and combining the first set of pixel values and the remaining pixels to regenerate a macroblock of pixels.

Regeneration of the first set of pixel values may comprise dequantising the first part of the signal, and inverse transforming a dequantised first part of the signal.

Regeneration of the remaining pixels from the macroblock of pixels may comprise assigning at least one value from the second part of the signal to each pixel.

Combining the first set of pixel values and the remaining pixels to regenerate a macroblock of pixels may comprise filtering the boundary between the first set pixels values and the remaining pixels.

The method may further comprise filtering the boundary of the macroblock. Filtering may comprises applying a de-blocking filter.

Dequantising the first part of the signal may further comprise decoding the position value associated with the first part of the signal.

According to a further aspect of the invention, there is provided a computer program comprising program code means adapted to perform a method as described above.

According to a further aspect of the invention, there is provided an apparatus comprising means for selecting a first set of pixels from a macroblock of pixels, means for transforming the first set of pixels, and means for encoding the transformed first set of pixels.

According to a further aspect of the invention, there is provided an apparatus comprising means for determining a first part of a signal representing a first set of pixel values from a macroblock of pixels, means for regenerating the first set of pixel values from the first part of the signal, means for regenerating the remaining pixels from the macroblock of pixels from a second part of the signal, and means for combing the first set of pixel values and the remaining pixels to regenerate a macroblock of pixels.

### BRIEF DESCRIPTION OF DRAWINGS

For better understanding of the present invention, reference will now be made by way of example to the accompanying drawings in which:

FIG. 1 shows schematically an electronic device employing embodiments of the invention;

FIG. 2 shows schematically a user equipment suitable for employing embodiments of the invention;

FIG. 3 further shows schematically electronic devices employing embodiments of the invention connected using wireless and wired network connections;

FIG. 4 shows schematically an embodiment of the invention as incorporated within an encoder;

FIG. 5 shows a flow diagram showing the operation of an embodiment of the invention with respect to the residual encoder as shown in FIG. 4;

FIG. 6 shows a schematic diagram of a decoder according to embodiments of the invention;

FIG. 7 shows a flow diagram of showing the operation of an embodiment of the invention with respect to the decoder shown in FIG. 6;

FIG. 8 shows a simplified representation of the filtering and coded block pattern (CDP) signalling according to an embodiment of the invention; and

FIG. 9 shows a simplified representation of a spatially varying transform block selection and offset from the macro block origin according to embodiments of the invention.

### DESCRIPTION OF PREFERRED EMBODIMENTS OF THE INVENTION

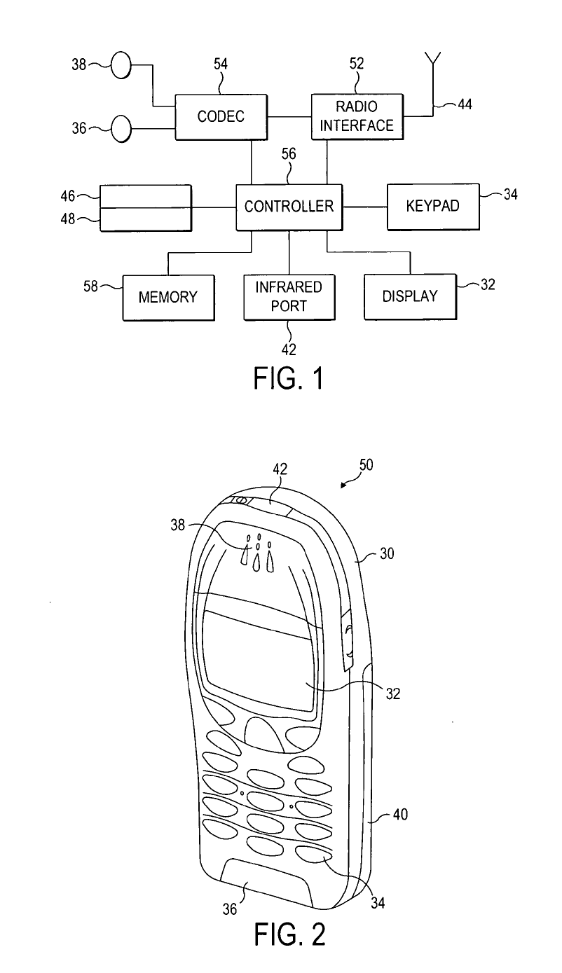

The following describes in further detail suitable apparatus and possible mechanisms for the provision of enhancing encoding efficiency and signal fidelity for a video codec. In this regard reference is first made to FIG. 1 which shows a schematic block diagram of an exemplary apparatus or electronic device 50, which may incorporate a codec according to an embodiment of the invention.

The electronic device 50 may for example be a mobile terminal or user equipment of a wireless communication system. However, it would be appreciated that embodiments of the invention may be implemented within any electronic device or apparatus which may require encoding and decoding or encoding or decoding video images.

The apparatus 50 may comprise a housing 30 for incorporating and protecting the device. The apparatus 50 further may comprise a display 32 in the form of a liquid crystal display. In other embodiments of the invention the display may be any suitable display technology suitable to display an image or video. The apparatus 50 may further comprise a keypad 34. In other embodiments of the invention any suitable data or user interface mechanism may be employed. For example the user interface may be implemented as a virtual keyboard or data entry system as part of a touch-sensitive display. The apparatus may comprise a microphone 36 or any suitable audio input which may be a digital or analogue signal input. The apparatus 50 may further comprise an audio output device which in embodiments of the invention may be any one of: an earpiece 38, speaker, or an analogue audio or digital audio output connection. The apparatus 50 may also comprise a battery 40 (or in other embodiments of the invention the device may be powered by any suitable mobile energy device such as solar cell, fuel cell or clockwork generator). The apparatus may further comprise an infrared port 42 for short range line of sight communication to other devices. In other embodiments the apparatus 50 may further comprise any suitable short range communication solution such as for example a Bluetooth wireless connection or a USB/firewire wired connection.

The apparatus 50 may comprise a controller 56 or processor for controlling the apparatus 50. The controller 56 may be connected to memory 58 which in embodiments of the invention may store both data in the form of image and audio data and/or may also store instructions for implementation on the controller 56. The controller 56 may further be connected to codec circuitry 54 suitable for carrying out coding and decoding of audio and/or video data or assisting in coding and decoding carried out by the controller 56.

The apparatus 50 may further comprise a card reader 48 and a smart card 46, for example a UICC and UICC reader for providing user information and being suitable for providing authentication information for authentication and authorization of the user at a network.

The apparatus 50 may comprise radio interface circuitry 52 connected to the controller and suitable for generating wireless communication signals for example for communication with a cellular communications network, a wireless communications system or a wireless local area network. The apparatus 50 further may comprise an antenna 44 connected to the radio interface circuitry 52 for transmitting and receiving radio frequency signals generated at the radio interface circuitry 52.

In some embodiments of the invention, the apparatus 50 comprises a camera capable of recording or detecting individual frames which are then passed to the codec 54 or controller for processing. In other embodiments of the invention, the apparatus may receive the video image data for processing from an adjacent device prior to transmission and/or storage. In other embodiments of the invention, the apparatus 50 may receive either wirelessly or by a wired connection the image for coding/decoding.

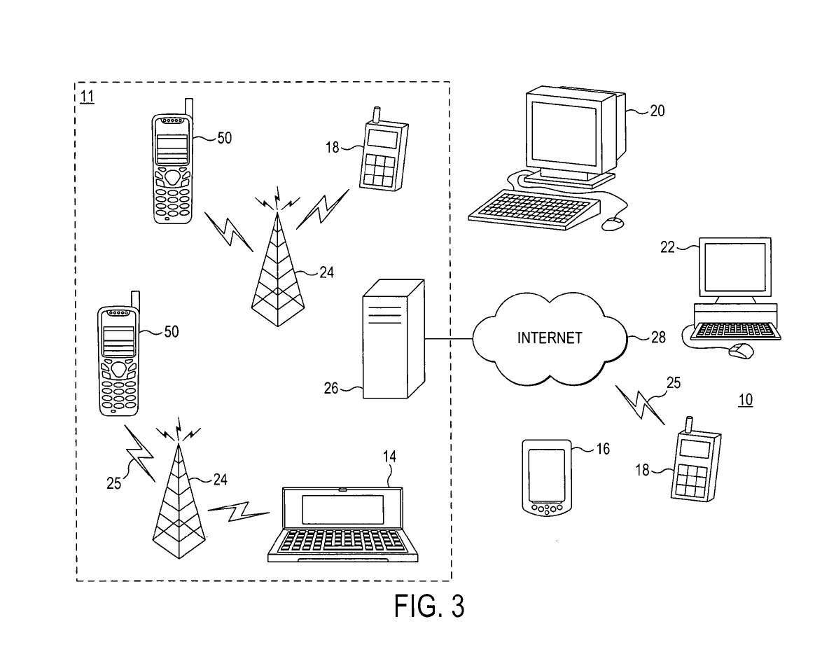

With respect to FIG. 3, a system within which embodiments of the present invention can be utilised is shown. The system 10 comprises multiple communication devices which can communicate through one or more networks. The system 10 may comprise any combination of wired or wireless networks including, but not limited to a wireless cellular telephone network (such as a GSM, UMTS, CDMA network etc), a wireless local area network (WLAN) such as defined by any of the IEEE 802.x standards, a Bluetooth personal area network, an Ethernet local area network, a token ring local area network, a wide area network, and the Internet.

The system 10 may include both wired and wireless communication devices or apparatus 50 suitable for implementing embodiments of the invention.

For example, the system shown in FIG. 3 shows a mobile telephone network 11 and a representation of the internet 28. Connectivity to the Internet 28 may include, but is not limited to, long range wireless connections, short range wireless connections, and various wired connections including, but not limited to, telephone lines, cable lines, power lines, and similar communication pathways.

The example communication devices show in the system 10 may include, but are not limited to, an electronic device or apparatus 50, a combination personal digital assistant (PDA) and mobile telephone 14, a PDA 16, an integrated messaging device (IMD) 18, a desktop computer 20, a notebook computer 22. The apparatus 50 may be stationary or mobile when carried by an individual who is moving. The apparatus 50 may also be located in a mode of transport including, but not limited to, a car, a truck, a taxi, a bus, a train, a boat, an aeroplane, a bicycle, a motorcycle or any similar suitable mode of transport.

Some or further apparatus may send and receive calls and messages and communicate with service providers through a wireless connection 25 to a base station 24. The base station 24 may be connected to a network server 26 that allows communication between the mobile telephone network 11 and the Internet 28. The system may include additional communication devices and communication devices of various types.

The communication devices may communicate using various transmission technologies including, but not limited to, code division multiple access (CDMA), global systems for mobile communications (GSM), universal mobile telecommunications system (UMTS), time divisional multiple access (TDMA), frequency division multiple access (FDMA), transmission control protocol-internet protocol (TCP-IP), short messaging service (SMS), multimedia messaging service (MMS), email, instant messaging service (IMS), Bluetooth, IEEE 802.11 and any similar wireless communication technology. A communications device involves in implementing various embodiments of the present invention may communicate using various media including, but not limited to, radio, infrared, laser, cable connections, and any suitable connection.

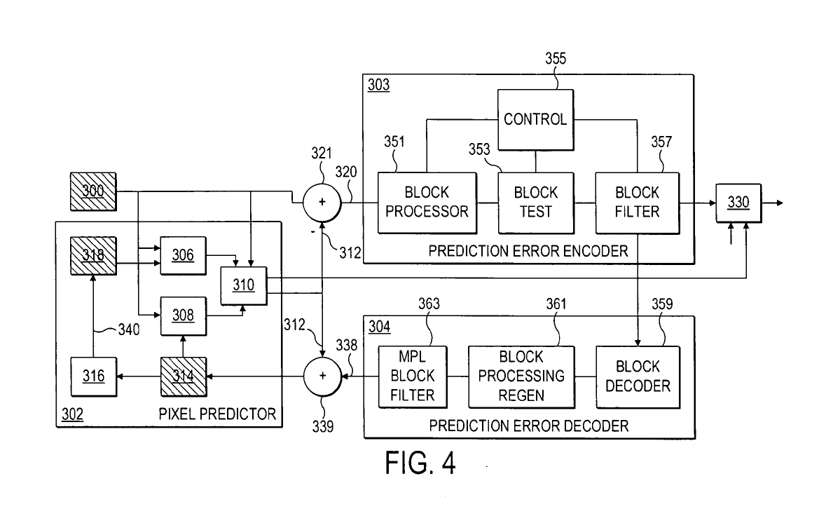

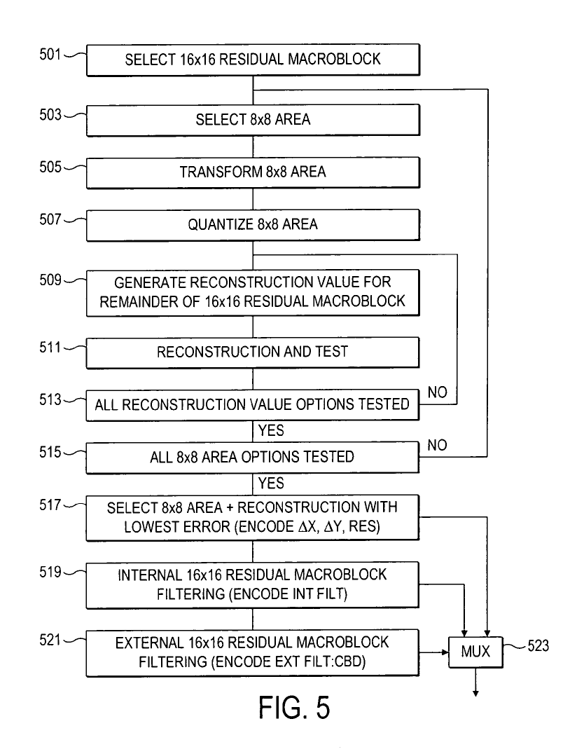

With respect to FIG. 4, a block diagram of a video encoder suitable for carrying out embodiments of the invention is shown. Furthermore, with respect to FIG. 5, the operation of the encoder exemplifying embodiments of the invention specifically with respect to the residual macro block encoding process is shown in detail.

FIG. 4 shows the encoder as comprising a pixel predictor 302, prediction error encoder 303 and prediction error decoder 304.

The pixel predictor 302 receives the image 300 to be encoded at both the inter-predictor 306 (which determines the difference between the image and a reference frame 318) and the intra-predictor 308 (which determines the image based only on the current frame or picture). The output of both the inter-predictor and the intra-predictor are passed to the mode selector 310. The mode selector 310 also receives a copy of the image 300. The output of the mode selector is the predicted representation of an image block 312 from either the intra-predictor 306 or intra-predictor 308 which is passed to a first summing device 321. The first summing device may subtract the pixel predictor 302 output from the image 300 to produce a first prediction error signal 320 which is input to the prediction error encoder 303.

The pixel predictor 302 further receives from a preliminary reconstructor 339 the combination of the prediction representation of the image block 312 and the output 338 of the prediction error decoder 304. The preliminary reconstructed image 314 may be passed to the intra-predictor 308 and to a filter 316. The filter 316 receiving the preliminary representation may filter the preliminary representation and output a final reconstructed image 340 which may be saved in a reference frame memory 318. The reference frame memory 318 may be connected to the inter-predictor 306 to be used as the reference image against which the image 300 is compared against in inter-prediction operations.

The operation of the pixel predictor 302 may be configured to carry out any known pixel prediction algorithm known in the art.

The operation of the prediction error encoder 302 and prediction error decoder 304 will be described hereafter in further detail. In the following examples the encoder generates images in terms of 16×16 pixel macroblocks which go to form the full image or picture. Thus for the following examples the pixel predictor 302 and the first summing device 321 output a series of 16×16 pixel residual data macroblocks which may represent the difference between a first macro-block in the image against a similar macro-block in the reference image or picture (in the inter-prediction mode) or an image macro-block itself (in the intra-prediction mode). It would be appreciated that other size macro blocks may be used. Furthermore although the following examples describe a selected 8×8 pixel block with respect to the selected block size it would be appreciated that different size selected blocks may be used in other embodiments of the invention.

The prediction error encoder 303 comprises a controller 355 which controls a block processor 351, block tester 353 and block filterer 357. The block processor 351 may receive the selected 16×16 pixel residual macroblock 320. The output of the block processor 351 is connected to the block tester 353. The block tester 353 is further connected to the block filterer 357. The output of the block filterer 357 is passed to the entropy encoder 330 and also to the prediction error decoder 304.

The entropy encoder 330 receives the output of the prediction error encoder and may perform a suitable entropy encoding/variable length encoding on the signal to provide error detection and correction capability. Any suitable entropy encoding algorithm may be employed.

The prediction error decoder 304 receives the output from the prediction error encoder 303 and performs the opposite processes of the prediction error encoder 303 to produce a decoded prediction error signal 338 which when combined with the prediction representation of the image block 312 at the second summing device 339 produces the preliminary reconstructed image 314. The prediction error decoder may be considered to comprise a block decoder which extracts the block values further described below, a block regenerator processor 361 which regenerates the block from the block decoder 359 values and a macroblock filter 363 which may filter the regenerated macroblock according to further decoded information and filter parameters.

The operation and implementation of the prediction error encoder 303 is shown in further detail with respect to FIG. 5.

The block processor 351 receives the 16×16 pixel residual macroblock or in other words, a 16×16 pixel residual macroblock is selected as shown in FIG. 5, step 501.

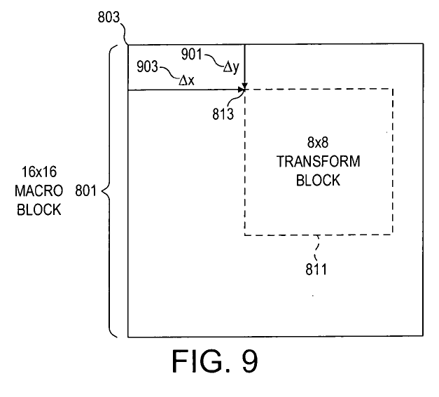

The controller 355 then initiates a loop control mechanism where the block processor 351 selects an 8×8 pixel residual block from the 16×16 pixel residual macroblock. With respect to FIG. 9, an example of the selection is shown whereby a 16×16 pixel residual macroblock 801 is shown within which an 8×8 pixel residual transform block 811 is shown. Furthermore as can be seen in FIG. 9, the 8×8 pixel residual transform block 811 may be defined with respect to the origin of the 16×16 pixel residual macroblock 801, by a first offset value Δx 903 and a second offset value Δy 903.

The block processor 351 then transforms the 8×8 pixel residual transform block 811 using any suitable transformation. For example, in some embodiments of the invention, the discrete cosine transform (DCT) is used to exploit the correlation between the original image and the pixel predicted image as a frequency domain two-dimensional array. However, in other embodiments of the invention, other suitable space to frequency domain transform may be implemented.

The operation of transforming the 8×8 pixel transform block is shown in FIG. 5 by step 505.

Furthermore, the block processor 351 performs a suitable quantisation on the 8×8 pixel transform block 811. Any suitable quantisation scheme may be employed including but not exclusively vector quantisation. In other embodiments of the invention each coefficient may be quantised independently. The operation of applying quantisation to the transformed 8×8 pixel transform block 811 is shown in FIG. 5 by step 507.

The block processor 351 furthermore generates a reconstruction value for the residual pixels in the remainder of the 16×16 pixel residual macroblock not selected as the 8×8 pixel transform block. The reconstruction values for the residual pixels in the remaining part of the 16×16 pixel residual macroblock are set to zero.

In alternative embodiments of the invention the residual pixel values in the part of the 16×16 residual macroblock which are not selected for transform may either be represented individually or jointly. For example, in some embodiments of the invention each one of the pixels in the remaining area may be represented by a fixed value where each value may be selected from the following set of values −1 (11, 2 bit) 0 (0, 1 bit), 1 (10, 2 bit). In further embodiments of the invention all the remaining pixel values may be represented as a single value selected from the above set of values.

The generation of the reconstruction value for the remainder of 16×16 pixel residual macroblock operation is shown in FIG. 5 by step 509.

The output of the block processor 351 in terms of the quantised 8×8 pixel transformed block 811 and the reconstruction value for the remainder of the 16×16 pixel residual macroblock are passed to the block tester 353. The block tester 353 may apply the minimization described above, C=D+λR, to produce a compromise between the error value D and the cost of the coding selection R (in terms of size or bit rate of the coding).

In order to carry out the optimization operation the block processor 351 determines the mean square error (or some other error value) between a reconstructed value using the values provided by the block processor 351 and the residual error image input to the prediction error encoder 303. The settings and the error value may be stored in a memory or within the controller 355.

The operation of testing the error between the transform and the quantised 8×8 pixel transformed block 811 in combination with the reconstruction value for the remainder of 16×16 residual macroblock and the input 16×16 residual macroblock 801 is shown in FIG. 5 by step 511.

The controller 355 then determines whether or not all reconstruction value options have been tested. This operation is shown in FIG. 5 by step 513. If all reconstruction value options have not been tested, the operation passes back to the step 509 and a further reconstruction value option is generated and tested. If all reconstruction value options have been tested, the operation passes to the step of determining whether all 8×8 pixel transformation block options have been tested.

The controller 355 further determines whether or not all 8×8 pixel transformation block 811 options have been tested. For a 16×16 residual macroblock there may be up to 81 possible combinations of Δx and Δy which may be represented by the vector of (Δx, Δy). The components of the vector (Δx, Δy) may be determined to have a value from a range of possible values of (0 . . . 8, 0 . . . 8). However, in embodiments of the invention the number of possible representations may be limited by the codec for practical reasons in order to improve coding efficiency and lower computational requirements. For example, a codec may select to utilize only 32 possible combinations of Δx and Δy which may be represented by the vector of (Δx, Δy) and represent the range of (0 . . . 8, 0), (0 . . . 8,8), (0,1 . . . 7), and (8,1 . . . 7). Each of these 32 combinations may be coded using a 5-bit length fixed code. Statistics show that it is more likely (Δx, Δy) will be one among (0 . . . 8, 0), (0 . . . 8,8), (0,1 . . . 7), and (8,1 . . . 7) as there are more likely more edges in the 8×8 block if it is in the centre of the macroblock where the transform becomes less efficient. If not all available 8×8 pixel transform block 811 options have been tested, the operation passes back to step 503 where a further 8×8 pixel transform block option is selected. Otherwise, the operation passes to the next step of selecting the lowest offset and reconstruction values with the lowest error. The operation of checking whether or not all 8×8 pixel transform block 811 options have been selected is shown in FIG. 5 by step 515.

The controller 355 furthermore selects the 8×8 pixel transform block 811 and reconstruction value which minimizes the cost function C=D+λR, in other words produces the lowest error for an acceptable bit rate/bandwidth consideration.

Furthermore, the controller may encode the Δx, Δy using the 5 bit fixed length code and the reconstruction value option code described above and pass this information to the multiplexer not shown. The operation of selecting or determining the coding options which minimize the cost function is shown in FIG. 5 by step 517.

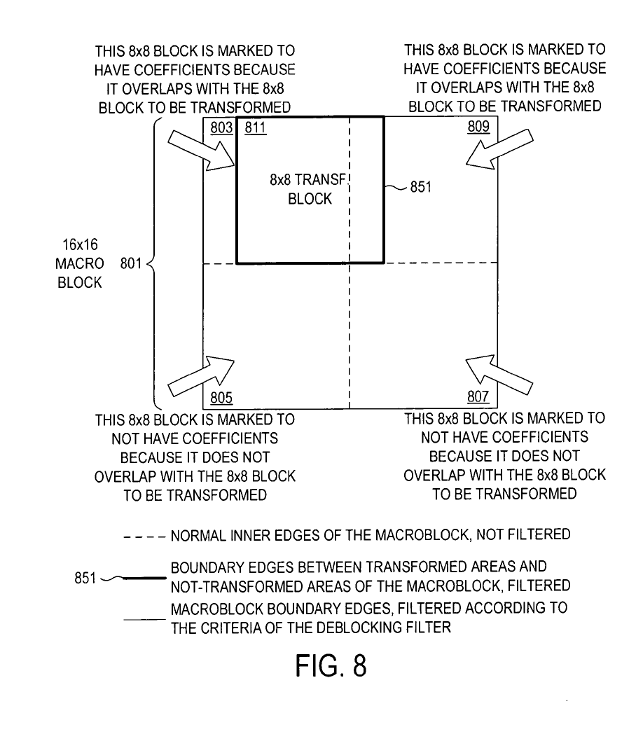

The controller 355 furthermore passes the 8×8 pixel transform block 811 information to the block filter 357. The block filter 357 then determines an internal filtering for the 16×16 pixel residual macroblock 801 with respect to the boundary of the 8×8 pixel transform block 811. With respect to FIG. 8, the filtered boundary edges between the 8×8 pixel transform block 811 and the non-transformed areas of the residual macroblock 801 are shown. The residual macroblock 801 and the 8×8 pixel transformation block 811 have a boundary 851 which is marked or designated for filtering. The filtering may be a deblocking filtering and may in embodiments of the invention be a deblocking filter similar to the one used for the reconstructed frame. The details of the filter may be further encoded and sent to the multiplexer.

The internal residual filtering determination operation is shown in FIG. 5 by step 519.

Furthermore, the block filter 357 may determine an external 16×16 pixel residual macroblock filtering process. This may be further described as being the coded block pattern (CBP) generation or derivation operation. One such method for determining whether or not a deblocking filter is to be applied on a specific 8×8 pixel partition of the 16×16 pixel residual macroblock is shown in FIG. 8. In FIG. 8, the 16×16 pixel residual macroblock 801 is shown divided into four-parts or quarters each 8×8 pixels. The first part 803 is the top-left quarter of the residual macroblock, the second part 805 the bottom-left quarter of the residual macroblock, the third part 809 the upper-right quarter of the residual macroblock and the fourth part 807 the bottom-right quarter of the residual macroblock. The example shown in FIG. 8 is that the CBP derivation indicates that the external deblocking filter needs to be applied to the external borders of the macroblock for the quarters where the 8×8 pixel transformation block 811 overlaps with the quarter. Thus for example as shown in FIG. 8 the 8×8 pixel transformation block overlaps with the first and third parts—the upper left and upper right quarters only and therefore only the macro block boundary edges on the top-left 803 and top-right quarters 809 respectively are indicated as being suitable for filtering and the bottom-left quarter 805 and bottom-right quarter 807 are not indicated as being suitable for filtering.

In some embodiments of the invention the encoder may only determine one of the internal and external filtering processes. For example, in an embodiment of the invention in the CBP derivation process only the CBP for the four 8×8 blocks inside the macroblock are derived and it is not decided whether to filter the normal inner edges and macroblock boundary edges. The filtering of the normal inner edges and macroblock boundary edges may in embodiments of the invention be decided according to other criteria besides CBP.

In other embodiments of the invention, other suitable coded block pattern (CBP) rules may be implemented.

The determination of the external 16×16 pixel residual macro block filtering is shown in FIG. 5 by step 521.

In some embodiments of the invention the operations of filter determination, either internal or external or both, may be carried out during the testing of the cost function. In such embodiments of the invention the cost of the filtering in terms of the processing and signalling information required to be transferred may also be used as a factor in the cost function determination and as such the configuration of the filtering of the macroblocks may be determined dependent on the cost function optimisation process.

Furthermore the encoded Δx, Δy, reconstruction values, and any internal or external filter information or coded block pattern values may be passed to a multiplexer which then multiplexes these values together with any reference information to form the output sequence of frame information. The application of the entropy encoding process by the entropy encoder may be implemented following multiplexing of the information. The multiplexing of these values is shown in FIG. 5 by step 523.

In other embodiments of the invention, there may be more than a single 8×8 pixel transform block within a 16×16 residual macroblock. In other words, in some embodiments of the invention, two or more separate areas are selected and encoded in order to further reduce the error. Furthermore in other embodiments of the invention the size of the pixel transform block is other then 8×8 pixels.

In other embodiments of the invention, different combinations of Δx and Δy are used.

In some embodiments of the invention, the 8×8 pixel block is encoded using spatial coding in other words is not transformed.

In other embodiments of the invention, the reconstruction value of the remainder of the residual macroblock may be determined dependent on the quantisation step and signalled separately in the sequence or the picture header.

In some embodiments of the invention, the encoding of the Δx and Δy values are jointly encoded to further exploit any correlation between the Δx and Δy values. In some embodiments of the invention, the Δx and Δy values are encoded separately.

In some embodiments of the invention, the coding used for Δx and Δy is selected dependent on factors such as the motion vector used for the macroblock or from information derived from neighbouring macroblocks.

In some embodiments of the invention, the coefficient of the specially varying transform are coded using entropy coding methods such as variable length coding tables.

The invention as implemented in embodiments of the invention therefore has advantages in that the encoder determines a region of the residual macroblock that is most optimally selected for transformation and attempts to more optimally exploit the correlation between the predicted image block and the image block. Furthermore, as will be described later, the decoder only requires coefficients for a single 8×8 pixel block transform to be decoded and thus the complexity of the decoder may be reduced while achieving a higher coding efficiency.

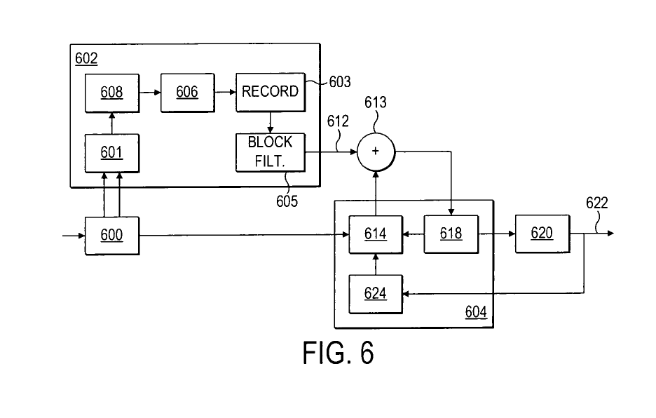

For completeness a suitable decoder is hereafter described. FIG. 6 shows a block diagram of a video decoder suitable for employing embodiments of the invention. The decoder shows an entropy decoder 600 which performs an entropy decoding on the received signal. The entropy decoder thus performs the inverse operation to the entropy encoder 330 of the encoder described above. The entropy decoder 600 outputs the results of the entropy decoding to a prediction error decoder 602 and pixel predictor 604.

The pixel predictor 604 receives the output of the entropy decoder 600 and a predictor selector 614 within the pixel predictor 604 determines that either an intra-prediction or an inter-prediction operation is to be carried out. The predictor selector furthermore outputs a predicted representation of an image block 616 to a first combiner 613. The predicted representation of the image block 616 is used in conjunction with the reconstructed prediction error signal 612 to generate a preliminary reconstructed image 618. The preliminary reconstructed image 618 may be used in the predictor 614 or may be passed to a filter 620. The filter 620 applies a filtering which outputs a final predicted signal 622. The final predicted signal 622 may be stored in a reference frame memory 624, the reference frame memory 624 further being connected to the predictor 614 for prediction operations.

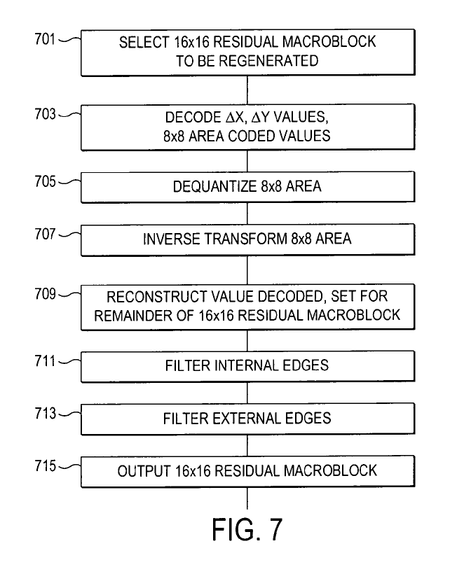

The operation of the prediction error decoder 602 is described in further detail with respect to the flow diagram of FIG. 7. The prediction error decoder 602 receives the output of the entropy decoder 600.

The decoder selects the 16×16 pixel residual macroblock to regenerate. The selection of the 16×16 pixel residual macroblock to be regenerated is shown in step 701.

The decoder 601 furthermore receives the entropy decoded values and separates and decodes the values into the Δx, Δy values (in other words the identification of the 8×8 pixel transformed block). The decoding of this is shown in FIG. 7 by step 703.

The dequantiser 608 dequantises the selected 8×8 pixel transformed block. The dequantisation of the 8×8 pixel transformed block is shown in FIG. 7 by step 705.

The inverse transformer 606 furthermore performs an inverse transformation on the selected dequantised 8×8 pixel transformed block. The operation of performing the inverse transformation is shown in FIG. 7 by step 707.

The inverse transformation carried out is dependent upon the transformation carried out within the encoder.

The reconstructor 603 furthermore decodes the reconstruction values and sets the remainder of the 16×16 pixel residual macroblock dependent on the value of the reconstruction value.

The decoding and reconstruction of the remainder of the 16×16 pixel residual macroblock is shown in FIG. 7 by step 709.

The block filter 605 receives the combined data from the 8×8 pixel transformed block and the reconstructed remainder of the 16×16 pixel residual macroblock and performs any internal edge filtering in a manner similar to that identified by the encoder.

The operation of internal edge filtering is shown in FIG. 7 by step 711.

Furthermore, the block filter 605 performs external edge filtering on the reconstructed 16×16 pixel residual macroblock dependent on the value of the coded block pattern information.

The operation of filtering the external edges of the macro block using the coded block pattern information is shown in FIG. 7 by step 713.

The block filter 605 and prediction error decoder 604 thus output the reconstructed 16×16 pixel residual macroblock to be combined with the current reference image output by the intra-prediction operation or inter-prediction operation to create a preliminary reconstructed image 618 as described above.

The embodiments of the invention described above describe the codec in terms of separate encoder and decoder apparatus in order to assist the understanding of the processes involved. However, it would be appreciated that the apparatus, structures and operations may be implemented as a single encoder-decoder apparatus/structure/operation. Furthermore in some embodiments of the invention the coder and decoder may share some/or all common elements.

Although the above examples describe embodiments of the invention operating within a codec within an electronic device, it would be appreciated that the invention as described below may be implemented as part of any video codec. Thus, for example, embodiments of the invention may be implemented in a video codec which may implement video coding over fixed or wired communication paths.

Thus user equipment may comprise a video codec such as those described in embodiments of the invention above.

It shall be appreciated that the term user equipment is intended to cover any suitable type of wireless user equipment, such as mobile telephones, portable data processing devices or portable web browsers.

Furthermore elements of a public land mobile network (PLMN) may also comprise video codecs as described above.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs) and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1-47. (canceled)

48. Apparatus comprising at least one processor and at least one memory including computer program code the at least one memory and the computer program code configured to, with the at least one processor, cause the apparatus at least to:
select a first set of pixels from a macroblock of pixels, wherein the macroblock of pixels is associated with a further block of pixels;
determine a correlation between the selected first set of pixels and a corresponding set of pixels from the further block of pixels; wherein the selection of the first set of pixels is based at least in part on the correlation between the selected first set of pixels and the corresponding set of pixels from the further block of pixels;
generate a cost function, wherein the cost function is based at least in part on the correlation between the selected first set of pixels and the corresponding set of pixels from the further block of pixels;
minimise the value of the cost function;
transform the first set of pixels; and
encode the transformed first set of pixels.

49. The apparatus as claimed in claim 48, wherein the first set of pixels are selected from at least one of a plurality of sets of pixels from the macroblock of pixels, wherein the cost function is based at least in part on the number of the plurality of sets of pixels, and wherein the at least one memory and the computer program code are further configured to, with the at least one processor, cause the apparatus at least to:
assign at least one value to the macroblock pixels that have not been selected.

50. The apparatus as claimed in claim 49, wherein the cost function value is further based on the number of values assigned to the macroblock pixels that have not been selected

51. The apparatus as claimed in claim 48, further configured to select a filter for application in the macroblock of pixels, wherein the cost function value is further based on the filter selection.

52. The apparatus as claimed in claim 49, wherein each of the plurality of sets of pixels from the macroblock of pixels is associated with a different position within the macroblock of pixels, and wherein the at least one memory and the computer program code are further configured to, with the at least one processor, cause the apparatus at least to:
assign a value indicating the position of the selected first set of pixels within the macroblock of pixels; and
encode the value indicating the position of the selected first set of pixels.

53. The apparatus as claimed in claim 52, wherein the at least one memory and computer program code configured to, with the at least one processor cause the apparatus at least to encode the value indicating the position of the selected first set of pixels is further configured to cause the apparatus at least to:
encode the value indicating the position of the selected first set of pixels based on information derived from the macroblock of pixels.

54. The apparatus as claimed in claim 52, wherein the at least one memory and computer program code configured to, with the at least one processor cause the apparatus at least to encode the value indicating the position of the selected first set of pixels is further configured to cause the apparatus at least to:
encode the value indicating the position of the selected first set of pixels based on information derived from a neighbouring macroblock of pixels.

55. The apparatus as claimed in claim 48, wherein the further block or pixels is based at least in part on the encoded transformed first set of pixels and the at least one value assigned to the macroblock pixels that have not been selected.

56. An apparatus comprising at least one processor and at least one memory including computer program code the at least one memory and the computer program code configured to, with the at least one processor, cause the apparatus at least to:
determine a first part of a signal representing a first set of pixel values from a macroblock of pixels;
regenerate the first set of pixel values from the first part of the signal by dequantizing the first part of the signal and inverse transforming a dequantized first part of the signal;
regenerate the remaining pixels from the macroblock of pixels from a second part of the signal by at least assigning at least one value from the second part of the signal to each pixel;
combine the first set of pixel values and the remaining pixels to regenerate a macroblock of pixels by at least filtering the boundary between the first set pixels values and the remaining pixels.

57. The apparatus as claimed in claim 56, wherein the at least one memory and the computer program code are further configured to, with the at least one processor, cause the apparatus at least to:
filter the boundary of the macroblock, wherein the filter comprises a de-blocking filter.

58. The apparatus as claimed in claim 56 wherein the at least one memory and the computer program code configured to, with the at least one processor, cause the apparatus at least to dequantise the first part of the signal is further configured to cause the apparatus at least to decode the position value associated with the first part of the signal.

59. A method comprising:
selecting a first set of pixels from a macroblock of pixels, wherein the macroblock of pixels is associated with a further block of pixels;
determining a correlation between the selected first set of pixels; wherein the selection of the first set of pixels is based at least in part on the correlation between the selected first set of pixels and the corresponding set of pixels from the further block of pixels;
generating a cost function, wherein the cost function is based at least in part on the correlation between the selected first set of pixels and the corresponding set of pixels from the further block of pixels;
minimizing the value of the cost function
transforming the first set of pixels; and
encoding the transformed first set of pixels.

60. The method of claim 59, wherein the first set of pixels are selected from at least one of a plurality of sets of pixels from a macroblock of pixels, wherein the cost function is based at least in part on the number of the plurality of sets of pixels, and wherein the method further comprises:
assigning at least one value to the macroblock pixels that have not been selected.

61. The method of claim 60, wherein the cost function value is further based on the number of values assigned to the macroblock pixels that have not been selected.

62. The method of any of claim 59 further comprising:
selecting a filter for application in the macroblock of pixels, wherein the cost function value is further based on the filter selection.

63. The method as claimed in claim 60, wherein each of the plurality of sets of pixels from the macroblock of pixels is associated with a different position within the macroblock of pixels, and the method further comprises:
assigning a value indicating the position of the selected first set of pixels within the macroblock of pixels; and
encoding the value indicating the position of the selected first set of pixels.

64. The method as claimed in claim 63, wherein encoding the value indicating the position of the selected first set of pixels further comprises:
encoding the value indicating the position of the selected first set of pixels based on information derived from the macroblock of pixels.

65. The method as claimed in claim 63, wherein encoding the value indicating the position of the selected first set of pixels further comprises:
encoding the value indicating the position of the selected first set of pixels based on information derived from a neighbouring macroblock of pixels.

66. The method as claimed in claim 59, wherein the further block or pixels is based at least in part on the encoded transformed first set of pixels and the least one value assigned to the macroblock pixels that have not been selected.

67. A method comprising:
determining a first part of a signal representing a first set of pixel values from a macroblock of pixels;
regenerating the first set of pixel values from the first part of the signal by at least dequantising the first part of the signal and inverse transforming a dequantised first part of the signal;
regenerating the remaining pixels from the macroblock of pixels from a second part of the signal by at least assigning at least one value from the second part of the signal to each pixel; and
combining the first set of pixel values and the remaining pixels to regenerate a macroblock of pixels by at least filtering the boundary between the first set pixels values and the remaining pixels.

68. The method of any of claim 67 further comprising filtering the boundary of the macroblock, wherein filtering comprises applying a de-blocking filter.

69. The method as claimed in claim 68 wherein dequantizing the first part of the signal is further comprises decoding the position value associated with the first part of the signal.
